(19) United States
(12) Patent Application Publication
(10) Pub. No.: US 2008/0312814 A1
(43) Pub. Date: Dec. 18, 2008

(54) Data Presentation for Navigation System

(75) Inventors: Matthew John Broadbent, Auckland (NZ); Bruce Matthew Callagher, Auckland (NZ)

Correspondence Address: LADAS & PARRY, 5670 WILSHIRE BOULEVARD, SUITE 2100, LOS ANGELES, CA, 90036-5679, US

(73) Assignee: MITAC INTERNATIONAL CORP., TAOYUAN (TW)

(21) Appl. No.: 11/916,798

(22) PCT Filed: Feb. 28, 2006
(86) PCT No.: PCT/NZ2006/000032

§ 371 Date: Jul. 9, 2008

(30) Foreign Application Priority Data
Jun. 16, 2005 (NZ) 540819

(51) Int. Cl. G01C 21/36

(52) U.S. Cl. 701/200

(57) ABSTRACT

An in-car navigation system (1) which, in response to a user query, outputs a modified list of results aimed at making it easier for a user to locate the intended result. In one aspect, the navigation system selectively merges together different matching results. In another aspect, the system decides which fields from each matching entry should be displayed in the results list so that the displayed results may be easily differentiated from one another by the user. In a further aspect, the system provides a country- or region-specific address presentation format so that a user may be presented with a full address in a manner which is typical of the country or region in which the address is found.

### BACKGROUND TO THE INVENTION

1. Field of the Invention

This invention relates to navigation systems and in particular, though not solely, to methods and apparatus for dynamically improving the search interface (or “map engine”) of a personal or vehicle navigation system so that, based upon a standard map data information file, the results of a search for a place name or location by a user are more concise, less ambiguous, more meaningful, and/or presented to the user in a more appropriate format for that user.

2. Background Art

Navigation systems such as personal or vehicle (or “in-car”) navigation systems usually utilise a GPS receiver and map data to determine a vehicle's current location. The position determined by the GPS receiver is combined with digital map data describing the environment within which the vehicle is positioned to provide a user with navigational information. For example, from the digital map data, the navigation system may create and display a geographical map of the area in which the user/vehicle is located with roads and/or points of interest and the user's (or user's vehicle's) present location superimposed thereon. Ordinarily a user is also provided with the ability to enter details of a desired destination and the navigation system will generate an appropriate route to the destination and display the route and/or audibly communicate directions to the user.

Map data for use by the navigation system consists in an electronic data file defining nodes connected by road segments. Unless a user identifies a complete and unique destination address, a destination address results list is generated with the closest matches to the user-entered address. Sometimes the results lists includes multiple entries for a single road. For example, State Highway 1 (often abbreviated as “SH1”) may appear in the results list as an entry for each of the suburbs through which State Highway 1 passes. That is, within Auckland, New Zealand, user entry of “State Highway 1” or “SH1” will ordinarily produce a results list of “SH1 Auckland CBD”, “SH1 Ellerslie”, “SH1 Greenlane”, “SH1 Newmarket”, “SH1 Remuera” etc (where Auckland CBD, Ellerslie and Greenlane are all suburbs of Auckland city).

A further example is PEEKS BROOK LANE, HORLEY in the UK. There is only a single Peeks Brook Lane in the UK and it is divided into two physically separate pieces 40 and 41 as shown in FIG. 4. However, at the priority date of this patent application, a search for “Peeks Brook Lane, Horley” via the on-line Internet service MAPQUEST® provided by Mapquest.com, Inc. (www.mapquest.co.uk) which is one of the world's largest consumer mapping and business solution providers, produces a results list containing eight identical matches. The reason for this is that digital map data contains defined (or “named”) regions at a number of levels or layers. For example, the digital map data provided for North America by Tele Atlas North America, Inc. (www.teleatlas.com) consists of a large number of layers, only some of which are included in the table below:

| Layer code | Description |
|---|---|
| A8 | County boundaries and Census population |
| A9 | Minor civil and county civil divisions or boundaries |
| | and Census population information. |
| AP | City and other municipal boundaries. Includes Census |
| | population information |
| OA1, OA2 | Other named areas - contains region information for |
| | Census areas |
| PD | Postal districts - contains region boundaries for |
| | US ZIP codes |
| PDEA | Postal district extended attributes - Links to PD, |
| | contains city names (database only) |

Search results lists are created by taking combinations of attributes across discrete elements at run time in order to present a list of roads or places to a user. Thus certain combinations of road name and various levels of named areas are assumed to define a unique searchable entity. Using this approach means that continuous roads that overlap multiple defined places or areas can be split into separate results. FIG. 5 shows the Tele Atlas “A8” (county or borough) boundaries as applied to Greater London in the United Kingdom. It should be remembered that the A8 boundaries are only one set of boundaries contained within the map data. FIG. 6 shows an enlarged region of the map of FIG. 5 and includes two roads 60 and 61, both of which have the name Abbey Road and both of which cross A8 boundaries. Accordingly, a user searching for either of these Abbey Roads at the county level will be provided with multiple results.

There are several other sources of name duplication in results lists. A road passing through the coverage area boundary of a map may create an additional results list entry for that road in combination with the high order administrative are boundary (for example, the road in combination with a city or country name if the map coverage area corresponds to a city or a country). Duplicate entries can also be produced in cases where the same name is used to represent more than one level of area type. For example, New York, N.Y. (where the first New York is the name of a city and the second New York is the name of a state) or Auckland, Auckland (where the first Auckland is the name of a city and the second Auckland is the name of a region).

As a result of result duplication, multiple entries in a results list are effectively referring to the same road (although different segments of it) and so the size of the result set is unnecessarily inflated necessitating the user wading through more results than is strictly necessarily. It would be possible to manually pre-process the map data to clump equivalent results together under a generic name however, this would reduce compatibility with older map data sets and increase the scope of map data changes required when map data is periodically updated.

A related problem in some navigation systems is referred to as “aliasing”. This problem occurs when multiple results which are actually separate roads close by each other are merged into a single entry in a results list by virtue of the fact that they have the same name and the same combination of area names. In this case, only one result will be presented to a user where several are actually needed. FIG. 7 is again a map of Greater London including Tele Atlas A8 (borough) boundaries but also showing (for the Outer London boroughs) each road 70 having the name High Street to illustrate the potential for aliasing errors. Aliasing can also occur when each piece of road has the same name and is in the same set of named areas.

In summary there are two main problems that cause results to be included in a results list that make little sense to users of the system. The two problems occur because the results are named at a level of granularity that is too fine (many roads being split across area boundaries), or at a level that is too coarse, creating aliasing (multiple results merged to one within the same area).

U.S. Pat. No. 5,285,391A, U.S. Pat. No. 6,473,770B and EP0838663A all disclose vehicle navigation systems in which the map data has been pre-processed to effectively or actually aggregate or merge road segments in order to reduce storage space requirements and to reduce computer processing time in route calculations.

Typically, the digital map data contains a table of street addresses and other points of interest along with their actual location; usually latitude and longitude co-ordinates of a location along or within the confines of the road or point of interest. Each entry in the table is made up of a number of fields. For example, in addition to latitude and longitude, 6 or 7 text fields may be used to fully and uniquely define each object or table entry (objects may include road segments, buildings or points of interest (“POI”)) in the table. Field titles may include house number, road name, place (or town or city or state) name and postal (or zip) code. Conventionally, each entry in a results list generated by a vehicle navigation system simply combines (or concatenates) each of the fields for a single object into a single line with adjacent fields separated by commas or the like. A problem with this approach is that it is often difficult to distinguish or differentiate particular entries in the results list from other entries because the information in many of the fields are common to all of the entries in the list (particularly the lower-level information such as town, city, state or country). This problem is exacerbated by the limited display width available on the screen associated with the navigation device meaning that many of the fields which could provide differentiability of entries in the results list are not able to be displayed.

U.S. Pat. No. 4,677,450A, US20040128064A and WO03100351A disclose navigation systems which attempt to overcome the differentiability problem in results lists by providing additional distinguishing information. In U.S. Pat. No. 4,677,450A the additional information is in the form of textual geographical information (for example, an additional prefecture or region field may be displayed) associated with any ambiguous entry in the results list. In US20040128064A, the additional information is also in the form of text providing the direction and/or distance to each of the ambiguous results list entries from a prominent point located near each respective result. In WO03100351A the additional information is in the form of a small graphical image such as a high level map indicating the region of a country in which each entry is found or an icon symbolising an industry or historical occurrence associated with the geographical region within which each entry in the results list is found.

U.S. Pat. No. 6,738,952A discloses a system for dealing with duplicate entries in a results list which are generated as a result of dividing the original unique multi-word addresses into separately indexed (but not necessarily unique) component words. An algorithm is provided for determining, based on a user input search term, which of the unique (whole) results list entries should be displayed. In U.S. Pat. No. 6,738,952A, any identical entries (such as entries for chain stores having the same name but different addresses) may be replaced by a single entry in the results list followed by a number indicating the number of entries in the data matching that name.

Conventionally, navigation systems display complete addresses in a single, standardised or generic pre-programmed format. However, it is common for manufacturers of navigation systems (such as vehicle navigation systems) to sell their products in a large number of countries, each of which may have particular standard address formatting conventions. Some manufacturers provide one generic address presentation format for all countries in which their devices are sold or incorporate different country-specific rules in each different country build of their navigation software applications. This type of system is however difficult and complicated to maintain.

It would therefore be advantageous to provide a navigation system in which the results provided in a results list were as concise and relevant as possible and/or the respective entries in the results list were easily differentiable from one another and/or addresses were formatted appropriately in a country-specific fashion in a way that did not complicate map data or applications software updating procedures.

In a first aspect, the invention consists in a navigation device comprising:

a data storage device containing map data identifying geographically distributed objects and their locations, each object identified by a series of separate data-containing object fields,

an input device to allow a user to provide input data indicative of a desired destination location,

control means which executes instructions causing it to search for objects amongst the map data having at least one field at least partially matching the input data and generates a results table populated with entries which each correspond to at least one matching object,
wherein each entry in the results table includes data from all or a predetermined selection of the object fields associated with each matching object, and
wherein, the control means selectively merges together two or more separate entries in the results table which have substantially equivalent data within predetermined corresponding object fields into a single merged entry, and
an output device which provides the user with the results table.

Preferably the data contained within each of the object fields is text data and for each object the object fields are ranked from a first, low level or more geographically refined object field to a last, high level or less geographically refined object field.

Preferably, the control means selectively merges separate matching objects as the results table is being populated.

Preferably, the control means populates the results table using a binary search function to determine the location in the results table to insert or merge each new matching result.

Preferably, a new matching result is merged with an existing entry in the results table if a comparison between the result and the entry passes at least one test.

Preferably, one of the tests includes dividing the object fields of the new matching result and an existing entry in the results table into a plurality of groups of object fields and carrying out a comparison between the two results on a group by group basis.

Preferably, within each group, the data from the new matching result and the existing entry in the preliminary results list is considered to match if the data contained within the object fields of one of the results appears in the same or different object fields of the other result.

Preferably, the map data identifies objects and their locations from a plurality of distinct map regions and the control means is able to merge at least some entries from different map regions.

Preferably, the map data also contains tuning data which controls the way in which the control means merges the two or more separate entries in the result stable.

Preferably, the tuning data controls the way in which the control means merges the two or more separate entries in the results table, in a manner which is dependent upon the geographical region or country in which those objects are located.

Preferably, the input device is adapted to allow a user to select an entry from the results table provided by the output device, wherein selection of a merged entry effectively selects all of the two or more separate matching entries which were merged together to form the merged entry.

Preferably, the output device provides the user with the results table subsequent to all matching objects having been merged together.

In a further aspect, the invention consists in a method of operating a navigation device comprising the steps of:

i) providing a data storage device containing map data identifying geographically distributed objects and their locations, each object identified by a series of separate data-containing object fields,

ii) inputting data indicative of a desired destination location,

iii) searching for objects amongst the map data having at least one field at least partially matching the input data,

iv) generating a results table populated with entries which each corresponds to at least one matching object, each entry in the results table including data from all or a predetermined selection of the object fields associated with each matching object, and

v) selectively merging together two or more separate entries in the results table which have substantially equivalent data within predetermined groupings of corresponding object fields into a single merged entry, and

vi) outputting the results table.

Preferably, the step of selectively merging separate matching objects happens as the results table is being populated.

Preferably, the results table is populated using a binary search function to determine the location in the results table to insert or merge each new matching result.

Preferably, a new matching result is merged with an existing entry in the results table if a comparison between the result and the entry passes at least one test.

Preferably, one of the tests includes dividing the object fields of the new matching result and an existing entry in the results table into a plurality of groups of object fields and carrying out a comparison between the two results on a group by group basis.

Preferably, within each group, the data from the new matching result and the existing entry in the preliminary results list is considered to match if the data contained within the object fields of one of the results appears in the same or different object fields of the other result.

Preferably, the map data identifies objects and their locations from a plurality of distinct map regions and the step of selectively merging is able to occur on at least some entries from different map regions.

Preferably, the map data also contains tuning data which controls the way in which the step of selective merging occurs.

Preferably, the tuning data causes the step of selective merging to merge the two or more separate entries in a manner which is dependent upon the geographical region or country in which those objects are located.

Preferably, the input step of inputting data allows a user to select an entry from the results table which has been output, wherein selection of a merged entry effectively selects all of the two or more separate matching entries which were merged together to form the merged entry.

Preferably, the step of outputting provides the user with the results table subsequent to all matching objects having been merged together.

In a further aspect, the invention consists in a navigation device comprising:

a data storage device containing map data identifying geographically distributed objects and their locations, each object identified by a series of separate text data-containing object fields,

an input device to allow a user to provide input data indicative of a desired destination location,

control means which executes instructions causing it to search for objects amongst the map data having at least one field at least partially matching the input data and generates a results table populated with entries which each correspond to at least one matching object, wherein each entry in the results table includes data from all or a predetermined selection of the object fields associated with a matching object, and wherein the control means also processes the objects in the results table to decide for each matching object which object fields to remove or hide to thereby minimise the amount of data in the results table while retaining sufficient data to allow the objects to be differentiated from one another, and

an output device which provides the user with the results table subsequent to processing.

Preferably, the control means alphabetically sorts the objects within the results table based upon a first object field of each object, selects a block of contiguous objects in the sorted results table which each have the same data within their first object field, and decides on which object fields to remove or hide for all objects within the selected block.

Preferably, the object fields are generally ranked from a first, low level or more geographically refined object field to a last, high level or less geographically refined object field.

Preferably, the first object field contains data describing the road name or street name or route name/number of the object.

Preferably, subsequent to sorting the results in the preliminary results table, for each object, the control means eliminates any multiple occurrences of the same text appearing in multiple object fields by deleting or hiding all but one of the multiple object fields.

Preferably, during processing, for any block containing a single object, all but the first and immediately adjacently ranked object fields are removed from or hidden in the results table.

Preferably, during processing, for any block containing more than one object, a counter is provided to determine and store a count, for each object field within the block, of the number of occurrences of each unique text string appearing in that object field over all of the objects, and for each object in the block, all but the first object field and the next most adjacently ranked object field having the lowest count are removed from or hidden in the results table.

Preferably, during processing, for any block containing more than one object, a counter is provided to determine and store a first count, for each object field within the block, of the number of occurrences of each unique text string appearing in that object field over all of the objects,

the unique text string within each object having the lowest first count is recorded in an eliminated names list,

the objects in the block are alphabetically sorted based upon the first object field and the next most adjacently ranked object field having the lowest first count,

a second count is made, for each object within the block where the unique text string having the lowest first count is not unique to that object, of the number of occurrences of each name appearing in that object field over all of the objects, excluding unique text strings appearing in the excluded names list, and

for each object in the block, all but the first object field and the next most adjacently ranked object field having the lowest first count and the next most adjacently ranked object field having the lowest second count are removed from or hidden in the results table.

Preferably, every separate contiguous block of objects in the results table is separately processed.

Preferably, the results table contains a predetermined maximum number of objects.

Preferably, the map data also contains tuning data which controls the way in which the control means processes the results table to differentiate objects from one another.

Preferably, the tuning data causes the control means to process the results table to differentiate objects from one another in a manner which is dependent upon the country in which those objects are located.

Preferably, immediately prior to the output means providing the user with the results table, the objects in the results table are alphabetically sorted based upon the first object field.

Preferably, the results table is output to the user only after the control means has completed processing it.

Preferably, matching objects are either exact matches whereby they match exactly with the input data or are inexact matches whereby some object's fields match the input data and those fields that do not match the input data match adjacent or nearly adjacent locations to the unmatched input data.

In a further aspect the invention consists in a method of operating a navigation device comprising the steps of:

i) providing a data storage device containing map data identifying geographically distributed objects and their locations, each object identified by a series of separate text data-containing object fields,

ii) inputting data indicative of a desired destination location,

iii) searching for objects amongst the map data having at least one field at least partially matching the input data,

iv) generating a results table populated with entries which each correspond to at least one matching object, each entry in the results table including data from all or a predetermined selection of the object fields associated with each matching object,

v) processing the objects in the results table to decide for each matching object which object fields to remove or hide to thereby minimise the amount of data in the results table while retaining sufficient data to allow the objects to be differentiated from one another, and

vi) outputting the results table.

Preferably, the processing step includes alphabetically sorting the objects within the results table based upon a first object field of each object, selecting a block of contiguous objects in the sorted results table which each have the same data within their first object field, and deciding on which object fields to remove or hide for all objects within the selected block.

Preferably, for each object the object fields are ranked from a first, low level or more geographically refined object field to a last, high level or less geographically refined object field.

Preferably, subsequent to sorting the results in the results table, for each object, the control means eliminates any multiple occurrences of the same text appearing in multiple object fields by deleting or hiding all but one of the multiple object fields.

Preferably, during processing, for any block containing a single object, all but the first and immediately adjacently ranked object fields are removed from or hidden in the results table.

Preferably, during processing, for any block containing more than one object, a counter is provided to determine and store a count, for each object field within the block, of the number of occurrences of each unique text string appearing in that object field over all of the objects, and for each object in the block, all but the first object field and the next most adjacently ranked object field having the lowest count are removed from or hidden in the results table.

Preferably, during processing, for any block containing more than one object, a counter is provided to determine and store a first count, for each object field within the block, of the number of occurrences of each unique text string appearing in that object field over all of the objects,

the unique text string within each object having the lowest first count is recorded in an eliminated names list,

the objects in the block are alphabetically sorted based upon the first object field and the next most adjacently ranked object field having the lowest first count,

a second count is made, for each object within the block where the unique text string having the lowest first count is not unique to that object, of the number of occurrences of each name appearing in that object field over all of the objects, excluding unique text strings appearing in the excluded names list, and

for each object in the block, all but the first object field and the next most adjacently ranked object field having the lowest first count and the next most adjacently ranked object field having the lowest second count are removed from or hidden in the results table.

Preferably, every separate contiguous block of objects in the results table is separately processed.

Preferably, the results table contains a predetermined maximum number of objects.

Preferably, the map data also contains tuning data which controls the way in which the results table is processed to differentiate objects from one another.

Preferably, the tuning data causes the processing step to differentiate the objects in the results table from one another in a manner which is dependent upon the country in which those objects are located.

Preferably, immediately prior to outputting the results table, the objects in the results table are alphabetically sorted based upon the first object field.

Preferably, the results table is output to the user only after the processing step has been completed.

In a further aspect, the invention consists in a navigation device comprising:

a data storage device containing map data identifying geographically distributed objects and their locations, each object identified by a series of separate data-containing object fields,

an input device to allow a user to select an object, and an output device which provides the selected object to the user by arranging its object fields in a predetermined format, wherein the format is selected from a plurality of formats dependent upon the geographical region or country in which the object is located.

Preferably, the input device allows the user to provide input data indicative of a desired destination location, the navigation device further comprising control means which executes instructions causing it to search for objects amongst the map data having at least one field at least partially matching the input data, wherein the input device allows the user to select a matching object which is then provided to the user by the output device in the selected predetermined format.

Preferably, the map data also contains tuning data for each country which defines the predetermined formats for each geographical region or country.

Preferably, the tuning data is comprised of metadata tags within the map data.

Preferably, the map-data contains data on objects from a plurality of countries or district geographic regions.

Preferably, the output device comprises a display screen or an audio output device which generates audible voice signals corresponding to the formatted object fields.

In a further aspect, the invention consists in a method of operating a navigation device comprising the steps of:

i) providing a data storage device containing map data identifying geographically distributed objects and their locations, each object identified by a series of separate data-containing object fields,

ii) selecting an object from the map data, and

iii) outputting the selected object to the user by arranging its object fields in a predetermined format, wherein the format is selected from a plurality of formats dependent upon the country or geographical region in which the object is located.

Preferably, the method further comprises further comprising the step of inputting data indicative of a desired destination location and searching for objects amongst the map data having at least one field at least partially matching the input data, wherein the selecting step is carried out on the matching objects.

Preferably, the map data also contains tuning data for each country which defines the predetermined formats for each geographic region or country and wherein the step of outputting is carried out based upon the tuning data.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF THE DRAWINGS

Preferred embodiments of the invention will now be described with reference to the accompanying drawings in which:

FIG. 1 is a schematic block diagram of a typical navigation system according to a preferred embodiment of the preset invention,

FIG. 2 is a flow diagram illustrating the “name differentiation” feature of the navigation system shown in FIG. 1,

FIG. 3 is a flow diagram of the concatenation algorithm within the flow chart of FIG. 2,

FIG. 4 is a screen-shot from an electronic map produced by Mapquest.com showing Peeks Brook Lane in the UK,

FIG. 5 is a map of Greater London showing the Tele Atlas A8 (borough) boundaries,

FIG. 6 is an enlarged view of a section of the map of FIG. 5,

FIG. 7 is a map similar to FIG. 5 showing each road named “High Street” in the Outer London boroughs,

FIG. 8 is a screen shot showing a results list generated without the benefit of the result merging or name differentiation features of the present invention,

FIG. 9 is a screen shot showing a results list generated for Peeks Brook Lane in the United Kingdom as a result of the result merging and name differentiation features of the present invention,

FIG. 10 is a flow diagram illustrating the “result merging” feature of the navigation system shown in FIG. 1,

FIG. 11 is a flow diagram of the result comparison function of the flow diagram of FIG. 10, and

FIG. 12 is a flow diagram of the result place comparison function of the flow diagram of FIG. 11.

### DETAILED DESCRIPTION OF THE PREFERRED EMBODIMENT

A navigation system 1, for example a vehicle navigation system is schematically shown in FIG. 1. The navigation system includes a GPS antenna 2 which provides GPS signals from receivable GPS satellites to a GPS receiver 3. GPS receiver 3 analyses the received GPS signals to determine its present location and passes this information on to a controller 4. Controller 4, which may include a microprocessor and associated or built-in memory devices adapted to execute instructions in the form of software code, also receives input from a user input device 5 which may comprise a keyboard and/or touch screen for example. User input could also comprise a voice recognition system wherein a user's spoken commands are translated for input to the controller.

A data storage device 6 holds digital map data describing the locations of objects such as streets or roads, street or road segments, buildings and landmarks or other points of interest in the vicinity (or at least the country) in which the user is situated. The data storage device preferably comprises a non-volatile memory device such as Flash drive, a non-removable hard drive or, in combination with a suitable reader device, a removable Secure Digital Card (SD Card) or a removable Multimedia Card (MM Card), all of which could allow the controller to also write data to the storage device. The data storage device may alternatively be provided as for example, a CD-ROM and player or DVD and player wherein the CD-ROM or DVD player may form part of an in-vehicle entertainment system. The data storage device is connected to the controller so that its content is accessible by controller 4.

Digital map data may be considered equivalent to a table including entries comprising a row in that table which each define a particular geographically located object. Each entry (or row) is made up of a series of fields (the columns) which hold a part of the information defining that object along with its geographical location (such as its GPS coordinates). The fields are ordinarily alphanumeric and may be ordered from a first or low level identifier (such as street or road) to a last or high level identifier (such as country). Street or road numbers may be contained within the map data although this information is often provided for only a subset of the objects and the locations of the street or road numbers for the remaining objects may then be calculated by interpolating between the locations of the known numbers.

An output device 7 is also connected to controller 4 to allow the controller to provide information to the user. The output device could, for example, comprise a display screen viewable by the user (often the driver of a vehicle) or could comprise an audio speaker which receives an amplified electrical signal produced by the controller which imitates or reproduces a human voice speaking the output information to the user.

In a vehicle navigation system as described above, controller 4 will usually display an image of the vehicle's present location, superimposed in real time on a map created by combining objects from the map data held in data storage device 6 and a location signal output by GPS receiver 3. Another function of such a vehicle navigation system is to allow a user to enter a desired destination location and have the navigation system determine or “plot” an appropriate route (along the “thoroughfare” objects such as street, roads and highways) to that destination location from the vehicle's present location. Whilst it would be possible for a user to enter sufficient information to totally uniquely define the destination location, this would be time consuming. Accordingly, usually a user enters a partial destination address or name and the controller will search through the digital data stored on data storage device 6 and present a resulting list of matching objects to the user. The user may then select one of the entries in the results list, thereby selecting that address as the desired destination address for routing to.

During the searching process, the controller may beneficially locate both “exact” matches and “inexact” (or “fuzzy-area”) matches for populating the results list. Exact matches comprise objects in which the user input search data (which may comprise data in more than one object field) matches field-for-field with an object in the map data. Fuzzy-area matches comprise objects from the map data which do not match field-for-field with the user input search data but which have a matching low level object field to the user input search data but may be located in an area (a slightly higher level object field) which does not exactly match the user input search data. For example, in New Zealand a user search input of “PUKERANGI CRESCENT, PENROSE” may produce a fuzzy-area search result match of “PUKERANGI CRESCENT, ELLERSLIE, AUCKLAND, NEW ZEALAND” because the user input suburb (PENROSE) is immediately adjacent to the actual suburb (ELLERSLIE) in which the thoroughfare (PUKERANGI CRESCENT) is located according to the map data.

The various features of the present invention are, both separately and in combination, directed at making the selection from the results list as easy as possible for a user. Whilst each of the following three features may be included in a navigation system independently, without the other two, to improve the ease by which a user may make a location selection, preferably the three features are all combined in a navigation system and most preferably, the three features are carried out in the following order.

### Result Merging

Duplicate address results entries may appear in the geocoding result list. This artificially enlarges the results list or, where the results list is limited to a predetermined maximum number of results (for example, 99 results), means that a possibly relevant result or results must be omitted from the list. Duplicate results may arise, for example, where route numbers (identifying major thoroughfares) are broken across every suburb within the digital map data. In this case, the resulting duplicate entries are identical except for one of their object fields. For example, a search for State Highway 1 (abbreviated to SH1) in New Zealand will usually include the following results within Auckland city.

SH1, AUCKLAND CBD, AUCKLAND CITY, NEW ZEALAND

SH1, ELLERSLIE, AUCKLAND CITY, NEW ZEALAND

SH1, GREENLANE, AUCKLAND CITY, NEW ZEALAND

SH1, NEWMARKET, AUCKLAND CITY, NEW ZEALAND

SH1, REMUERA, AUCKLAND CITY, NEW ZEALAND

Each object represents an individually identifiable object within the map data representing a segment of SH1 passing through a particular suburb of Auckland City.

This feature of the present invention discerns whether multiple results can be combined into one combined entry in the results list. This is achieved by controller 4 firstly generating a preliminary results list or data table of matches from the map data stored within storage device 6 in response to user input data. The preliminary results list is populated by objects in which the input data matches a name in an object field up to a maximum of, for example, 99 entries (or objects). User input of “SH1” as a thoroughfare would result in all of the above entries for SH1 appearing in the preliminary results list.

The preliminary results list may contain all or only a predetermined set of the fields associated with each object. The preliminary results list is not immediately provided to a user. Duplicate objects in the preliminary results list are first merged at some higher level, for example at city level, so that each of the above five SH1 objects within Auckland City are merged into a single combined entry as follows:

SH1, AUCKLAND CITY

Similar merged results entries for other groupings of SH1 within other New Zealand cities would include:

SH1, MANUKAU CITY

SH1, NORTH SHORE CITY

Effectively, the suburb fields for each pre-merged object have been deleted or made unpresentable or hidden in the preliminary results list. Once all possible duplicate entries have been merged in the preliminary results list, that list is output to the user as the search results list or data table from which the user can make a selection of a desired destination. If a user were to select a merged result (such as SH1, AUCKLAND CITY as shown above), the navigation system would interpret the selection as a selection of all of the objects which were merged into that single object. The improved result merging decreases the number of ambiguous selections available to the user which makes it much easier for users to select a destination.

Merging could be carried out after all matching objects have been added to the preliminary results list or more preferably, as a matching object is found it may be merged into the list. The latter option would of course mean that the preliminary results list would eventually become the final results list, subsequent to the final matching object being merged into the preliminary results list. In other words, the preliminary results list could be considered a non-final version of the results list.

Objects within the preliminary results list can be merged both within maps (each map may describe an entire country or a smaller region such as a state for example) and across multiple map regions (such as different countries within a single map of Europe) dynamically. Merging also takes into account the type of result that is being recovered and also how the data has been populated for a particular country. This information is encoded using “tuning” meta-data parameters within the map data that can be varied on a per region, such as country, basis. For example, as in the above example, the tuning meta-data may stipulate that for objects defining thoroughfares (roads, streets or state highways for example) located within New Zealand, result merging is to be carried out at city level.

This feature of the invention is conducted “on the fly” rather than requiring time consuming pre-processing of the map data files and so retains compatibility with older map data sets and limits the scope of data changes required each time new map data is produced.

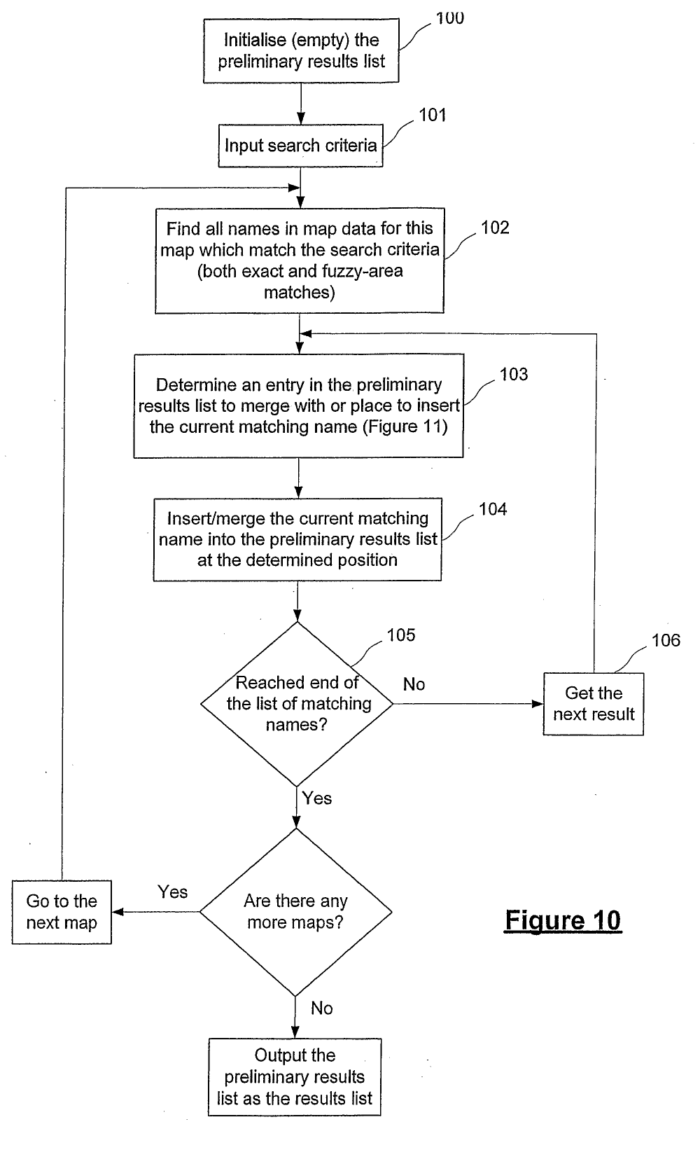

A preferred example of the result merging feature of the present invention will now be described in further detail with reference to FIGS. 10 to 12.

The flow diagram of FIG. 10 describes the overall result merging feature of the invention. At block 100 processing commences with initialisation of an preliminary results list. Search criteria are input via user input device 5 at block 101. The user input may, for example, comprise a partial road or place name which may be limited by a higher level area name. For example, the user may be searching for “KAWANA STREET, NORTHCOTE, AUCKLAND, NEW ZEALAND” but have simply input “KAW” and limited the search to only return results within the Auckland region. The output device 7 of the navigation system 1 could, for this purpose, provide a graphical user interface on a display screen with controller 1 executing an interactive computer program (or software “Wizard”) acting as an interface to lead a user while entering the search criteria in separate input fields which may include road or place name, area name or postal code for example.

At step 102 controller 4 searches through the digital map data stored in memory storage device 6 for exact matches and preferably also fuzzy-area matches to the input search criteria. In the case of fuzzy-area matches, a fuzzy-area flag is preferably set to enable the fuzzy-area results to be distinguished from the exact matches (as the exact matches are more likely to be of importance to the user). Depending upon how the map data is formatted, this typically results in a temporary list or table of matching road or street names which are indexed or referenced to further object fields containing data defining each higher level place name for that road. Alternatively, each road name could be represented (in the preliminary results list) by an index value into a table containing all road names in the map data. There could also be a place name table containing entries for every place name in the map data and a further table having multiple columns providing information linking associated entries in the road name and place tables together and having entities for multiple place names associated with each road name. The digital map data is prepared by a map provider and it is usually the case that for most larger or more densely developed countries, more than one map will be necessary within the map data to completely cover that country. Accordingly, steps 102 to 105 are first carried out on a first map and if any further maps exist for that country/region then a loop is entered to return to step 102 and to carry out the search on the next map. This is repeated until all maps in the map data have been searched.

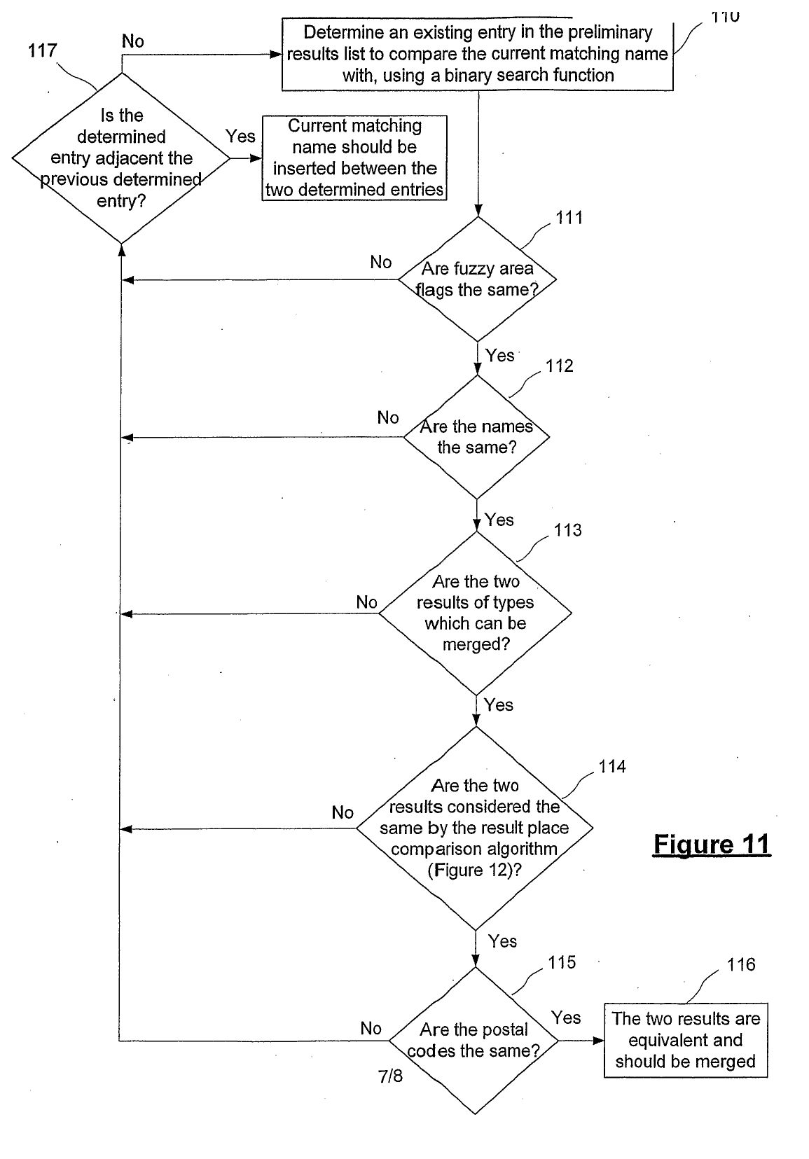

Within the loop, at steps 103 and 104 the preliminary results list is populated with the matching results. Firstly at step 103 (and as described in more detail below with reference to FIG. 11) each of the matching names are in turn compared to the preliminary results list to find either the place in the preliminary results list to insert the matching name (in alphabetical or alphanumerical order) or, if appropriate (as also described further below), an entry with which to merge. At step 104, depending upon the result of the comparison in step 103, the new matching result is either inserted into the preliminary results list at the identified position or it is merged with the identified entry in the preliminary results list. The merging process results in a single preliminary results list entry representative of the two (or more as a merged entry may be merged additional times) equivalent matching results and is linked to each of the original results.

Once the current matching entry has been inserted or merged into the preliminary results list, the next matching result is obtained from the temporary list or table at step 106 and steps 103 and 104 repeated until all matching results have been inserted or merged into the preliminary results list. Once this process has been completed for all maps in the digital map data the preliminary results list may be output via output device 7 as the actual results list. Alternatively, the list of results subsequent to this result merging process could be utilised as the input to the address differentiation algorithm described below to further clarify the results prior to output to the user.

With reference now to FIG. 11 the result comparison function carried out in step 103 of FIG. 10 to determine where in the preliminary results list the next matching result should be inserted or merged will be described. At step 110 a binary search function is utilised to determine an entry in the preliminary results list for comparison with the next matching result (to be inserted or merged). A binary search function is well known in the art and is an efficient algorithm which repeatedly divides an ordered search space in half according to how the new value compares with the middle element of the search space. The binary search therefore starts at the middle location of the preliminary results list and carries out a series of comparison tests (111 to 115) which all must be met if it is to be decided that the current location in the preliminary results list should be merged with the new matching result.

If any of the tests are not satisfied then the binary search function determines a new location in the preliminary results list to carry out the tests on, each time halving either the group of entries in the preliminary results list above or below the current entry to find a new entry for comparison with the new matching result. When two consecutive iterations of the binary search function determine entries in the preliminary results list which are adjacent to one another, neither of which satisfy all of the comparison tests, then it is decided that the new matching result should be inserted between those two entries and control passes to block 104 of FIG. 10.

In order for the binary search to work properly, it is critical that the direction (either up or down) that the binary search function moves in from the current entry to find the new entry for comparison with is consistent (or “deterministic”). Accordingly, in one example, if a test reveals a difference, then a return value based upon a numerical difference between the values is set and returned to the binary function to use in determining whether to next move up or down in the preliminary results list. For example, if the return value is a negative value then the new matching result should be inserted or merged somewhere before or above the current location in the preliminary results list, a positive return value would indicate that the new matching result should be inserted or merged somewhere after or below the current location and a return value of zero may indicate that the new matching result should be merged with the entry at the current location.

In the example shown in FIG. 11 the comparison search tests start with test 111 which compares the fuzzy-area flags of the entry in the preliminary results list with the new matching result. This ensures that fuzzy-area matches are kept separate from exact matches as they should not be merged. Each fuzzy-area flag may, for example be set by a value of 1 and not set by having a value of zero so that if the flags are different then the return value may be set to the difference between the values of the two flags.

Test 112 compares the name of the new matching result with the name of the entry in the preliminary results list at the currently determined location. If the two names are different then the return value may be set to the result of a string compare of the two names. A string compare function may for example provide a result of −1, 0, or 1 depending on whether the first character string is lexicographically less than, equal to or greater than the second character string where “lexicographically less than, equal to or greater than” is in terms of the strings' ASCII values.

It may be necessary or desirable to set certain types of results to be able to be merged across maps whereas it may be necessary or desirable for some other types of results not to be able to be merged across maps. For example, it may be practical not to allow road names to be merged across maps whereas place names may be merged across maps. If the results can be merged across maps then a flag may be set to indicate this. A determination may then be made as to whether the results are from the same map. If the two results are from different maps and can not be merged across maps then the return value may be set to the difference in the values of each map (each map having a predetermined numerical value). If the results are from the same map or are from different maps but are capable of being merged then this test is passed and test 114 is considered.

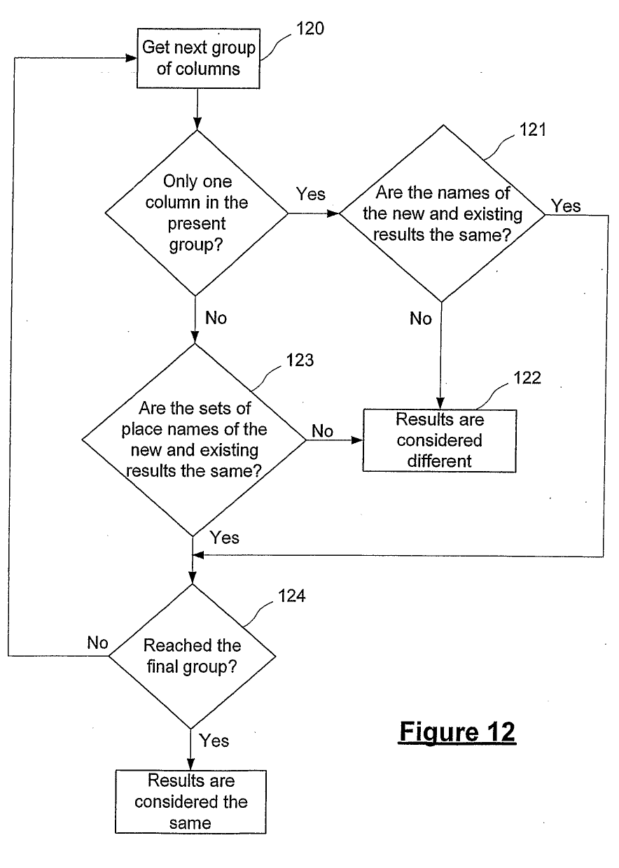

Test 114 compares the place data (but not postal codes preferably) of the two results. The comparison is described in more detail below with reference to the result place comparison algorithm shown in FIG. 12.

Test 115 compares the postal codes of the two results. It should be noted that we prefer that postal codes only be retained in the results where the user has specified a postal code in the search criteria and so in most cases the postal codes will be empty or not exist. Accordingly, if no postal codes exist then processing would continue to step 116 where it is concluded that the two results are equivalent and should be merged and then returns to step 103 of FIG. 10. If postal codes do exist then they are compared and if they are different then the return value may be the result of a string compare of the two postal codes. If the two postal codes are the same then the results are considered equivalent and processing would return to step 103 of FIG. 10. As mentioned previously, if two consecutive iterations of the binary search determine adjacent preliminary results list entries neither of which should be merged, then the decision step 117 provides an exit to the binary search function with instructions to insert the new matching result between the two determined entries.

As mentioned previously, test 114 compares the place data of the two results. There may for example, be seven place columns defined for each result, each of which contain place data of a consecutively higher level. One or more contiguous place columns may be grouped together for the purposes of the result place comparison algorithm shown in FIG. 12. In this algorithm, a whole group of place columns are compared between the two results. If the set of place names in the group is the same in both results then the two groups are considered equivalent. If all groups are considered equivalent then the two results' places are considered equivalent. In this way, the comparison process is able to configurably ignore the relative positions of the place names in object fields or columns within the groups of the two different results while still checking whether the actual place names appear within the group of columns. The grouping of columns is configurable in the map data through metadata tuning parameters which may, for example, define the following groupings:
Columns 0 to 4 are considered a single group representing a place
Column 5 is considered a single group representing a region (or state)
Column 6 is a single group representing a country

At step 120 the first group of object fields or place columns are obtained for both the results, if there is only one field or column in the group then the two place names are compared at step 121. If the two place names are different then the two results are considered different at step 122 and control returns to step 110 in FIG. 11 and a return value equal to the result of a string compare of the two place names may be returned to the binary search function. If the two place names are the same then the next group of place object fields or columns are obtained for each result (unless there are no further groups available). If the next group of columns obtained at step 120 includes more than one place name object field or column then at step 123 the sets of place names stored in the group of columns within the new matching result and the existing preliminary results list result are compared. It is possible that a place name may occur multiple times within a single group for one of the results. In this case, the duplicate appearance is ignored for the purpose of comparing the sets of place names.

If the two sets of place names are identical (noting that the relative positions of the place names within a particular group in the two results need not be the same) then the next group of place name object fields or columns are obtained. If there no further groups exist then at step 124 the two results are considered the same and control passes to test 115 of FIG. 11. Alternatively, the results are considered different at step 122 and control returns to the binary search function at step 110 of FIG. 11. The value returned to the binary search function may, for example, be determined as follows:

a) if the comparison at step 123 reveals that the set of place names from the new matching result is a strict subset of the set of place names from the existing preliminary results list result then a value of −1 may be returned,

b) if the comparison at step 123 reveals that the set of place names from the existing preliminary results list result is a strict subset of the set of place names from the new matching result then a value of +1 may be returned, or

c) otherwise, it is necessary to return a non-zero result to the binary search function in a deterministically consistent way. So, for example, if (as previously mentioned) each place name is represented by an index value into a table of place names, when determining which names to compare in the next step, the return value may be produced by a string compare function carried out on the column from each group (possibly in different columns) with the lowest valued place name index within its group such that the name represented by the place name index does not occur in the other group. Because neither group is a subset of the other (see (a) and (b) above) there is guaranteed to be at least one place name in each group that does not appear in the other. By carrying out a string compare function on two guaranteed different names, the return value will be non-zero as required. By choosing a lowest valued place name index to compare (such that the name represented by the place name index does not occur in the other group) a consistent return value would be assured even if, for example, two arbitrary columns within a single group appeared in a different order.

### Name Differentiation

The process of result merging improves but may not entirely eliminate duplication and therefore on occasions single entities may still generate multiple results list entries. In these cases further action is required to ensure that a non-ambiguous selection is possible by ensuring that results are differentiated in some way. The problem can be trivially solved by appending further place names from lowest to highest order fields in the place hierarchy. However, even in these cases the produced results list entries made up of name pairs or name triples may still be non-unique. In the worst-case scenario as many differentiating names are required as there are levels in the place hierarchy. This simple approach can therefore result in very long text strings which become confusing for the user.

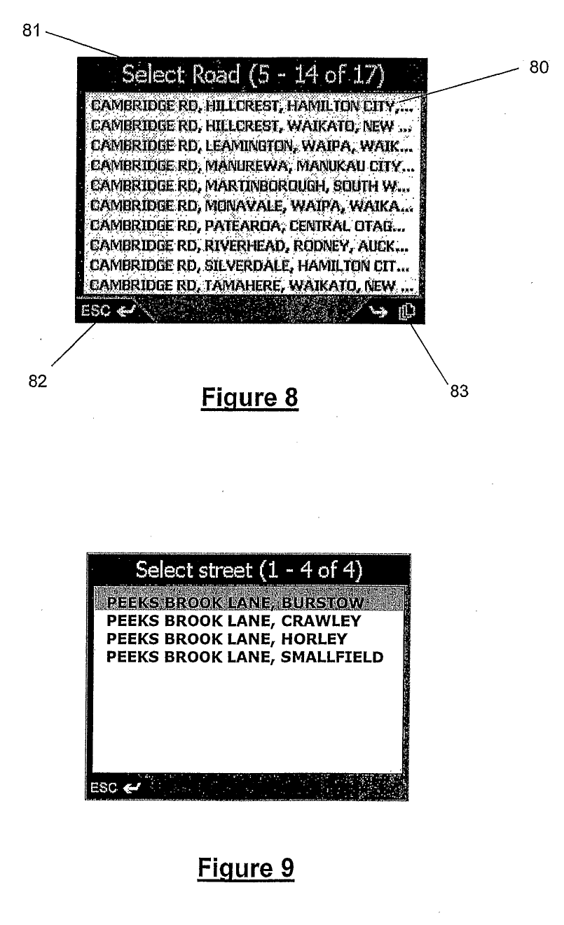

An example results list generated using a prior art system (that is, without the present result merging or name differentiation features) is shown in FIG. 8. The results list of FIG. 8 was produced by searching for “CAMBRIDGE ROAD, HILLCREST” amongst New Zealand map data. It can be seen in FIG. 8 that ten separate results 80 (each consisting of a row of concatenated name and place fields) are displayed out of a total of 17. Currently, results 5 to 14 are being displayed as indicated by the heading 81 of the window which is requesting that the user select one of the entries. A user may highlight and select any one of the entries to thereby choose that result address for further processing (such as routing to that address). Buttons or indicators 82 and 83 are provided to show further options available to the user. If the user presses the “Esc” key as indicated by option 82 then processing will return to a preceding step whereas pressing the key indicated by option 83 will cause processing to continue to a subsequent step.

The results list displayed in FIG. 8 includes duplication of “CAMBRIDGE RD, HILLCREST” in the first two rows currently displayed (note that Waikato is a regional area including Hamilton City) and also as “CAMBRIDGE RD, SILVERDALE” (Silverdale and Hillcrest are neighbouring suburbs of Hamilton, New Zealand). The duplication problem is further exacerbated where parts of the differentiating names have disappeared off to the right-hand side of the screen (“ . . . ” at the end of the entry indicates that it has been truncated).

An algorithm has been designed to produce display name entries for the results list which ensures that separate and distinct results are differentiated appropriately, typically by appending a single place name. Unlike many existing approaches, the name differentiation algorithm does not create the final form of the results list as it is being built. Instead, after the whole results list is known (that is, a preliminary results list containing a predetermined maximum number of matching objects has been generated), the information stored in all matching results is used to determine the best differentiating names to use for each item. This decreases the number of ambiguous selections available to the user. In summary, differentiating names are determined by eliminating the similarities between results and by examining the remaining differences.

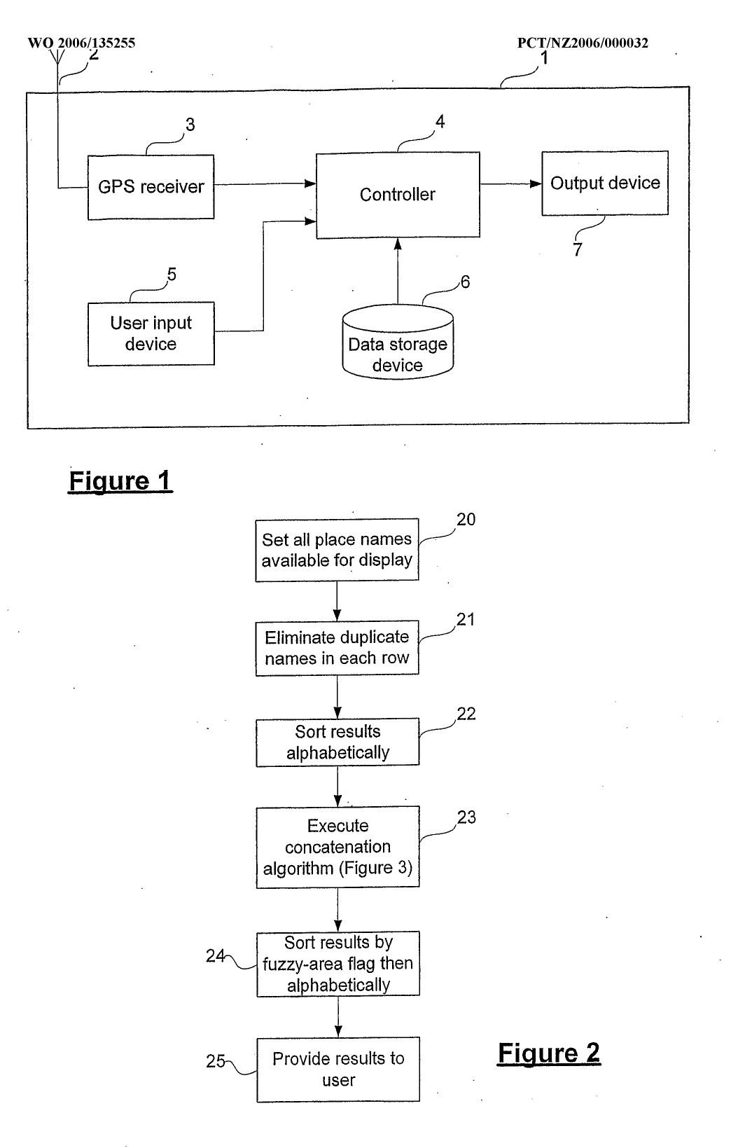

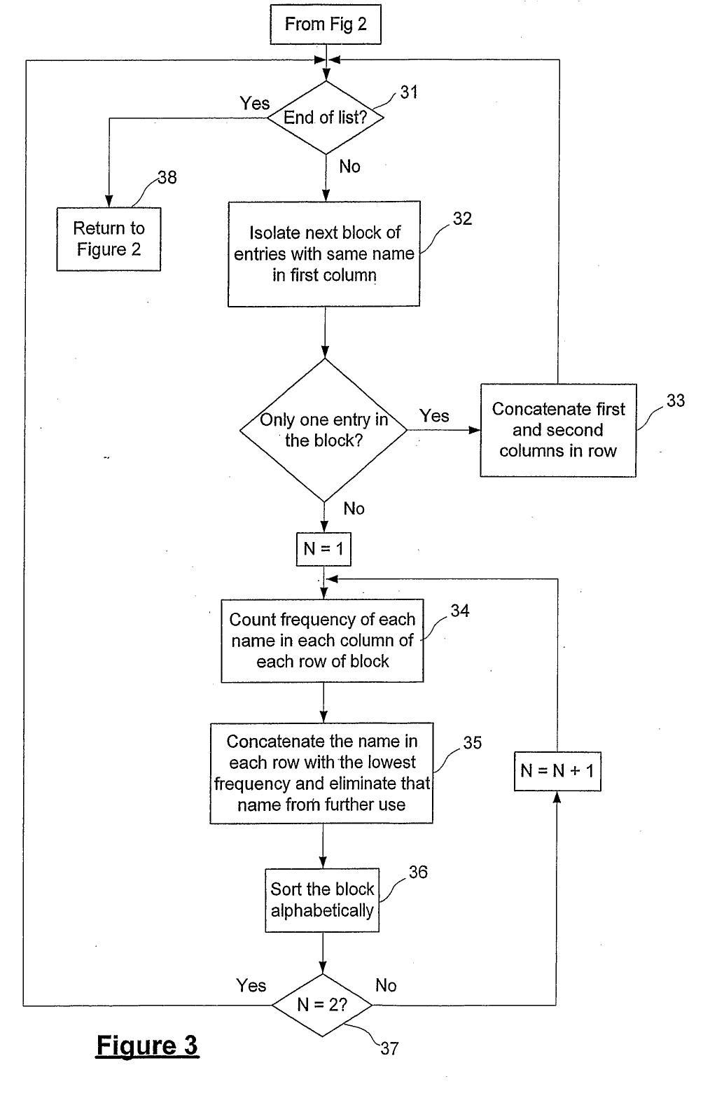

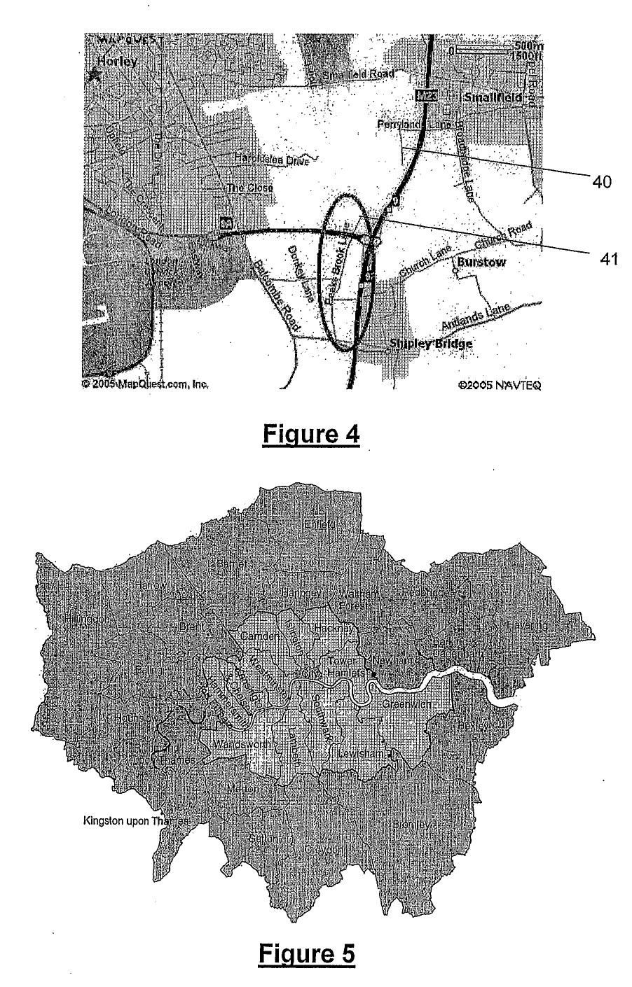

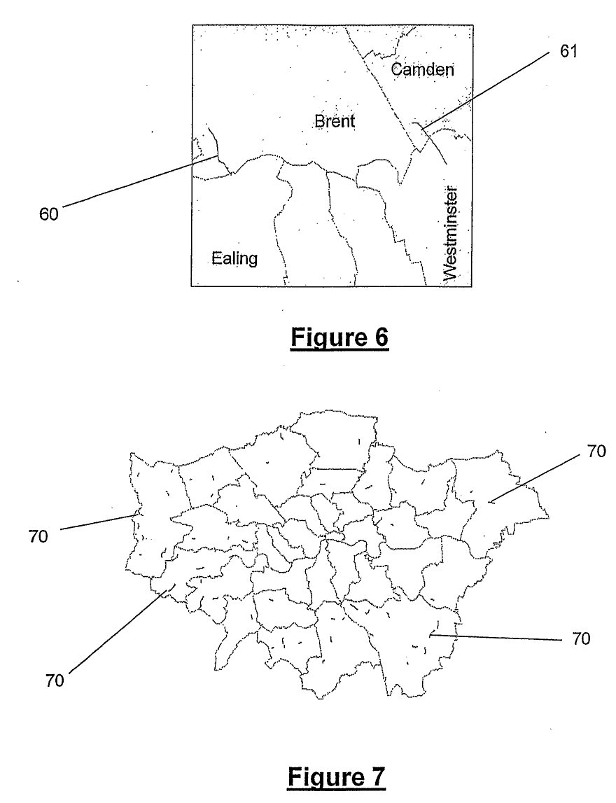

With reference now to the flow chart of FIG. 2, once the preliminary results list has been populated (and preferably result merging has been completed), the name differentiation algorithm starts with an initial step 20 of setting all place name columns in the preliminary results list available for display. The columns in the preliminary results list are ordered from low level to high level object fields so that the country name field (the highest level field) is at the end of each row. At step 21 duplicate names in a single row of the preliminary results list are eliminated. Duplicate names in a single row may, for example, occur due to an error in the original map data where the same name has been used to fill two adjacent object fields for one object. An example is “ . . . AUCKLAND, AUCKLAND, . . . ”. Removal of one of the duplicates immediately improves the appearance of that entry in the preliminary results list and improves the list's general clarity.

At step 22 the preliminary results list is sorted alphabetically based primarily upon the first (low level) object field so that objects are grouped together in blocks based on name to bring fuzzy-area results together with exact match results. At block 23 a recursive concatenation algorithm (described in more detail with reference to FIG. 3 below) is executed to decide which of the object fields should remain in the preliminary results list to minimise the number of fields provided to the user while maximising the user's ability to distinguish the objects in the list from one another. At step 24 the preliminary results list is again alphabetically sorted. However, to ensure that fuzzy-area results are moved back to the bottom of the list again (because there is a lower probability that they are the results which the user requires so they are the last to be presented to the user), the results are first sorted based upon whether their fuzzy-area flag has been set. Finally, at step 25, the preliminary results list is converted to or becomes the results list which is provided to the user via output device 7.

With reference now to the flow chart of FIG. 3, the concatenation algorithm of step 23 will now be described in more detail.

At block 31 a check is carried out to see if the concatenation algorithm has reached the end of the preliminary results list and if so then control reverts to step 24 of the flow chart of FIG. 2. Assuming that the end of the preliminary results list has not yet been reached, at step 32 the next block of entries having the same name in their first object field (column 1) are isolated. If there is only one object in the block then at step 33, then the first available name from the lowest level column is concatenated with the first object field and the other object fields in that row deleted or made unpresentable in the preliminary results list. In practice, this will usually mean that the first and second object fields are concatenated together (separated by a comma for example).

If more than one object is contained within the current block then a loop is entered which is stepped through twice (firstly for counter N=1 and secondly for N=2). At block 34 within the loop, a count is made of every name (or word) within all of the object fields within each object of the block. The frequency of occurrence of each name is associated with that name or word. There can be at most one occurrence of each name per row due to step 21 (FIG. 2).

At step 35 the name or word in each row (or object) that has the lowest frequency count is concatenated with the name in the lowest level column (with a comma or similar in between) and that name (with the lowest frequency in that row) is eliminated from being used again in the loop (for example, by being recorded in a temporary “excluded names” list). If the lowest frequency count is common to more than one column in a particular row then any one of the lowest frequency count words may be concatenated with the first column word but usually the closest (or “next most adjacent”) lowest frequency word will be used. At step 36 the rows in the block are alphabetically sorted based upon at least the first column and the chosen lowest frequency word.

Decision block 37 causes the loop of steps 35, 36 and 37 to be repeated twice on each block containing more than one object to handle cases where the same name was concatenated to more than one row and further name differentiation is required.

The process is repeated on each block of objects within the preliminary results list having the same name in their first column until the end of the preliminary results list is reached and control returns, via step 38, to step 23 of FIG. 2.

In the case of PEEKS BROOK LANE, HORLEY, UK (referred to in the introduction to this patent specification), the name differentiation algorithm herein described produces only four results as shown in FIG. 9. It will be appreciated and it can be seen that the number of entries in the results list has been reduced from eight (in the prior art example) to four and all four of the results have been differentiated clearly from one another by using only two concatenated fields per entry.

### Address Presentation

Once an address in the results list is selected by a user, it may be displayed and/or audibly output to the user in full in an appropriate format. Every country or geographic region has a specific default address output format in which its residents expect to have a selected address presented to them. Some navigation systems have a fixed address display format in which the same generic address output format is used in every country but this often results in user confusion because too many address fields are usually shown and the format is not familiar to users in many countries. An example of a generic address presentation format for our address is shown below and which typically displays far too many address fields which are not ordered in the way that people in New Zealand are accustomed:

13 Kawana Street,

Northcote,

North Shore City,

Auckland [city],

Auckland [province],

New Zealand.

Thus, the display format for entities and names that are recovered are pre-determined at the time maps are built. This leads to a fairly simple and reliable search implementation but means that these systems have a certain lack of flexibility in terms of what is displayed to the user. Alternatively, different country specific rules could be incorporated in each different build of their software.

According to this feature of the present invention, data that governs how addresses are presented for a particular country is built into the digital map data as meta-data. The meta-data may include information about the positioning of new line characters, placement of each address field or element and even prefix and suffix characters and field separators (such as commas or hyphens). In this way we are able to dynamically alter the way that addresses are shown depending on in which country the address result lies. This hybrid approach operates with both old and new digital map datasets using format rules built into the system only for historic data sets. This makes the system easily applicable to all future countries to which map coverage is extended.

This address presentation feature is applicable to the presentation of search results in a navigation device but is also equally applicable generally to the display of any selected object from the map data, whether or not it results from a search. For example, a user may simply click on an object in a map and its address may be displayed to the user in an appropriate format as described below.

As an example, the format for addresses located within New Zealand may be described as:

<number> <street> <new line>
<suburb> <new line>
<settlement> <postal code> <new line>
<country > <new line>

Our address would therefore be displayed as:

13 Kawana Street

Northcote

Auckland 1309

New Zealand

More address display format examples for several other countries are shown below:

| Country | Format | Example |
|---|---|---|
| Australia | <number> <street> | 21 Ramsey St |
| | <suburb> <state> <post code> | Erinsburgh Vic 3001 |
| | <country> | Australia |
| Austria | <street> <number> | Beethovengasse 25 |
| | <post code> <city> | 1020 Wien |
| | <country> | Austria |
| Belgium | <street> <number> | Rue du diamante 215 |
| | <post code> <town> | 4800 Verviers |
| | <country> | Belgium |
| Canada | <number> <street> | 14 Greenmann Drive |
| | <settlement> <province> <post code> | Kingston ON K7M 7T5 |
| | <country> | Canada |

The address format is described in terms of address elements (or fields) such as the road name, POI (point of interest) name, certain levels of place name, country name and so on. The following table lists the basic display elements from which address formats are constructed:

| Element name | Description |
|---|---|
| ADDRESS_ELEMENT_POI_NAME | Primary name of a Point of Interest - |
| | may be a branch name or a specific POI |
| | name. e.g. New York Metropolitan |
| | Museum. |
| ADDRESS_ELEMENT_ALT_POI_NAME | Alternate name of a Point of Interest - |
| | may be a brand or a franchise name, |
| | e.g. McDonalds ®. |
| ADDRESS_ELEMENT_POI_TYPE | Point of Interest type description - e.g. |
| | Bar |
| ADDRESS_ELEMENT_ALT_POI_TYPE | Alternative or additional point of |
| | interest type description - e.g. Food and |
| | Drink. |
| ADDRESS_ELEMENT_HOUSE_NUMBER | The house number of the location. |
| ADDRESS_ELEMENT_ROAD_NAME | Primary road name of the location - |
| | e.g. Northern Motorway. |
| ADDRESS_ELEMENT_ALT_ROAD_NAME | Secondary road name of the location or |
| | route number - e.g. SH1 |
| ADDRESS_ELEMENT_INT_ROAD_NAME | The name of an intersecting road name |
| | used when reporting intersection |
| | addresses. |
| ADDRESS_ELEMENT_SETTLEMENT_NAME | The name of a town, city or settlement |
| | location where the address is not street/ |
| | house number specific. |
| ADDRESS_ELEMENT_PLACE_NAME | A containing area name which could |
| | represent a suburb, city, town, district, |
| | etc. |
| ADDRESS_ELEMENT_POSTAL_CODE | The postal code of the location. |

It will be seen from the above table that alternate names may be incorporated into the displayed address (for example, ADDRESS_ELEMENT_ALT_POI_TYPE). This is useful for roads which can have multiple names or route numbers and points of interest which can have an associated brand or franchise name. Displaying additional names such as these can be useful for result clarification purposes.

In relation to ADDRESS_ELEMENT_PLACE_NAME, place types in map data are generally arranged into a loose hierarchy which has a different interpretation from one country to another. In general there is a many to one mapping between place types in the source data and the locations in which these appear in the formatted address display. For example, the range of minor place types representing suburb, village, town or city, may all map to a “last line” place name in the address format string whereas the place type representing region may map to the “second line” place name in the address format. The mapping of place types in the source data to display lines in the address format is usually much easier at the region or country level where a single place type maps to a single address element display position.

Navigation systems provide search functions to return a number of different result types such as full house number and street addresses, street names and places, various types of area names and postal codes. For efficiency purposes in this example the full address format for a group of countries is described once in such a way that the formats for multiple result types in multiple countries can be derived from one description. Address formats are given in order of first item displayed to the last item displayed. Several display formats are listed below to illustrate how they can be constructed in terms of the address elements mentioned above:

| | | | | | |
|---|---|---|---|---|---|
| Element | min | max | newline | prefix | suffix |

NEW ZEALAND
<number> <street>
<suburb>
<settlement><postal code>
<country>

| | | | | | |
|---|---|---|---|---|---|
| ADDRESS_ELEMENT_POI_NAME | 0 | 0 | FALSE | “” | “ ” |
| ADDRESS_ELEMENT_ALT_POI_NAME | 0 | 0 | TRUE | “(” | “)” |
| ADDRESS_ELEMENT_POI_TYPE | 0 | 0 | FALSE | “” | “ ” |
| ADDRESS_ELEMENT_ALT_POI_TYPE | 0 | 0 | TRUE | “” | “ ” |
| ADDRESS_ELEMENT_HOUSE_NUMBER | 0 | 0 | FALSE | “” | “ ” |
| ADDRESS_ELEMENT_ROAD_NAME | 0 | 0 | FALSE | “” | “ ” |
| ADDRESS_ELEMENT_ALT_ROAD_NAME | 0 | 0 | TRUE | “(” | “)” |
| ADDRESS_ELEMENT_INT_ROAD_NAME | 0 | 0 | TRUE | “” | “” |
| ADDRESS_ELEMENT_SETTLEMENT_NAME | 0 | 0 | FALSE | “” | “ ” |
| ADDRESS_ELEMENT_PLACE_NAME | 0 | 3 | TRUE | “” | “ ” |
| ADDRESS_ELEMENT_PLACE_NAME | 4 | 5 | FALSE | “” | “ ” |
| ADDRESS_ELEMENT_POSTAL_CODE | 0 | 0 | TRUE | “” | “ ” |
| ADDRESS_ELEMENT_PLACE_NAME | 6 | 6 | TRUE | “” | “” |

UNITED KINGDOM
<number> <street>
<suburb>
<county>
<post code>
<country>

| | | | | | |
|---|---|---|---|---|---|
| ADDRESS_ELEMENT_POI_NAME | 0 | 0 | FALSE | “” | “ ” |
| ADDRESS_ELEMENT_ALT_POI_NAME | 0 | 0 | TRUE | “(” | “)” |
| ADDRESS_ELEMENT_HOUSE_NUMBER | 0 | 0 | FALSE | “” | “ ” |
| ADDRESS_ELEMENT_ROAD_NAME | 0 | 0 | FALSE | “” | “ ” |
| ADDRESS_ELEMENT_ALT_ROAD_NAME | 0 | 0 | TRUE | “(” | “)” |
| ADDRESS_ELEMENT_INT_ROAD_NAME | 0 | 0 | TRUE | “” | “” |
| ADDRESS_ELEMENT_SETTLEMENT_NAME | 0 | 0 | TRUE | “” | “” |
| ADDRESS_ELEMENT_PLACE_NAME | 0 | 3 | TRUE | “” | “” |
| ADDRESS_ELEMENT_PLACE_NAME | 4 | 4 | TRUE | “” | “” |
| ADDRESS_ELEMENT_POSTAL_CODE | 0 | 0 | TRUE | “” | “” |
| ADDRESS_ELEMENT_PLACE_NAME | 5 | 6 | TRUE | “” | “” |

USA, AUSTRALIA, CANADA
<number> <street>
<suburb> <state> <post code>
<country>

| | | | | | |
|---|---|---|---|---|---|
| ADDRESS_ELEMENT_POI_NAME | 0 | 0 | FALSE | “” | “ ” |
| ADDRESS_ELEMENT_ALT_POI_NAME | 0 | 0 | TRUE | “(” | “)” |
| ADDRESS_ELEMENT_HOUSE_NUMBER | 0 | 0 | FALSE | “” | “ ” |
| ADDRESS_ELEMENT_ROAD_NAME | 0 | 0 | FALSE | “” | “ ” |
| ADDRESS_ELEMENT_ALT_ROAD_NAME | 0 | 0 | TRUE | “(” | “)” |
| ADDRESS_ELEMENT_INT_ROAD_NAME | 0 | 0 | TRUE | “” | “” |
| ADDRESS_ELEMENT_SETTLEMENT_NAME | 0 | 0 | FALSE | “” | “ ” |
| ADDRESS_ELEMENT_PLACE_NAME | 0 | 4 | FALSE | “” | “ ” |
| ADDRESS_ELEMENT_PLACE_NAME | 5 | 5 | FALSE | “” | “ ” |
| ADDRESS_ELEMENT_POSTAL_CODE | 0 | 0 | TRUE | “” | “” |
| ADDRESS_ELEMENT_PLACE_NAME | 6 | 6 | TRUE | “” | “” |

AUSTRIA, BELGIUM, GERMANY, NORWAY, SWEDEN, SWITZERLAND, NETHERLANDS
<street> <number>
<post code> <city>
<country>

| | | | | | |
|---|---|---|---|---|---|
| ADDRESS_ELEMENT_POI_NAME | 0 | 0 | FALSE | “” | “ ” |
| ADDRESS_ELEMENT_ALT_POI_NAME | 0 | 0 | TRUE | “(” | “)” |
| ADDRESS_ELEMENT_ROAD_NAME | 0 | 0 | FALSE | “” | “ ” |
| ADDRESS_ELEMENT_HOUSE_NUMBER | 0 | 0 | FALSE | “” | “ ” |
| ADDRESS_ELEMENT_ALT_ROAD_NAME | 0 | 0 | TRUE | “(” | “)” |
| ADDRESS_ELEMENT_INT_ROAD_NAME | 0 | 0 | TRUE | “” | “” |
| ADDRESS_ELEMENT_POSTAL_CODE | 0 | 0 | FALSE | “” | “ ” |
| ADDRESS_ELEMENT_SETTLEMENT_NAME | 0 | 0 | FALSE | “” | “ ” |
| ADDRESS_ELEMENT_PLACE_NAME | 0 | 5 | TRUE | “” | “” |
| ADDRESS_ELEMENT_PLACE_NAME | 6 | 6 | TRUE | “” | “” |

The above formatting element information is preferably included electronically in the digital map data as meta-data tags.

Each column in the format table above describes how a particular address element is formatted and has the following interpretation:

| Field | Type | Width | Decimals | Description |
|---|---|---|---|---|
| ID | N | 12 | 0 | 32 bit country ID code |
| ELEMENT | N | 6 | 0 | Refers to an element type above |
| MIN (short | N | 6 | 0 | Place name elements can refer to a range of |
| for | | | | place types with lowest order minplace |
| MINPLACE) | | | | |
| MAX (short | N | 6 | 0 | Place name elements can refer to a range of |
| for | | | | place types with highest order maxplace |
| MAXPLACE) | | | | |
| NEWLINE | N | 6 | 0 | an optional new line separator can be used |
| | | | | between this and the next display element |
| PREFIX | C | 4 | | If an address element is present the prefix |
| | | | | characters are printed before the address element |
| | | | | is displayed. |
| SUFFIX | C | 4 | | If an address element is present the suffix |
| | | | | characters are appended to the address element |
| | | | | after it is displayed. |

In the above tables, MIN and MAX refer to the ranking of place name fields which may be used. As previously mentioned, place name fields are preferably ordered from a low level to a high level (or vice versa). The low level place name fields include road or street names whereas the highest level place name field holds a country name. For example, place name field number 3 may hold suburb names while place name field number 6 may contain country names.

As a result of this feature of the invention, fewer (but a more correct) set of fields are shown in an output address, in the correct position for each country. Rather than being hard-coded this feature of the invention is infinitely extensible through alterations to the map data, and thus the “map engine” (or navigation software) only requires format rules encoded for historic map data sets while new data sets can include all relevant address formatting meta data. As a result, the address display format is very flexible such that addresses are shown as people native to a particular geographic region or country would expect them to appear.

1. A navigation device comprising:
a data storage device containing map data identifying geographically distributed objects and their locations, each object identified by a series of separate data-containing object fields,
an input device to allow a user to provide input data indicative of a desired destination location,
control means which executes instructions causing it to search for objects amongst the map data having at least one field at least partially matching the input data and generates a results table populated with entries which each correspond to at least one matching object,
wherein each entry in the results table includes data from all or a predetermined selection of the object fields associated with each matching object, and
wherein, the control means selectively merges together two or more separate entries in the results table which have substantially equivalent data within predetermined corresponding object fields into a single merged entry, and
an output device which provides the user with the results table.

2. A navigation device as claimed in claim 1, wherein the data contained within each of the object fields is text data and for each object the object fields are ranked from a first, low level or more geographically refined object field to a last, high level or less geographically refined object field.

3. A navigation device as claimed in claim 1, wherein the control means selectively merges separate matching objects as the results table is being populated.

4. A navigation device as claimed in claim 3, wherein the control means populates the results table using a binary search function to determine the location in the results table to insert or merge each new matching result.

5. A navigation device as claimed in claim 4, wherein a new matching result is merged with an existing entry in the results table if a comparison between the result and the entry passes at least one test.

6. A navigation device as claimed in claim 5, wherein one of the tests includes dividing the object fields of the new matching result and an existing entry in the results table into a plurality of groups of object fields and carrying out a comparison between the two results on a group by group basis.

7. A navigation device as claimed in claim 6, wherein within each group, the data from the new matching result and the existing entry in the preliminary results list is considered to match if the data contained within the object fields of one of the results appears in the same or different object fields of the other result.

8. A navigation device as claimed in claim 7, wherein the map data identifies objects and their locations from a plurality of distinct map regions and the control means is able to merge at least some entries from different map regions.

9. A navigation device as claimed in claim 8, wherein the map data also contains tuning data which controls the way in which the control means merges the two or more separate entries in the result stable.

10. A navigation device as claimed in claim 9, wherein the tuning data controls the way in which the control means merges the two or more separate entries in the results table, in a manner which is dependent upon the geographical region or country in which those objects are located.

11. A navigation device as claimed in claim 10, wherein the input device is adapted to allow a user to select an entry from the results table provided by the output device, wherein selection of a merged entry effectively selects all of the two or more separate matching entries which were merged together to form the merged entry.

12. A navigation device as claimed in claim 11, wherein the output device provides the user with the results table subsequent to all matching objects having been merged together.

13. A method of operating a navigation device comprising the steps of:
i) providing a data storage device containing map data identifying geographically distributed objects and their locations, each object identified by a series of separate data containing object fields,
ii) inputting data indicative of a desired destination location,
iii) searching for objects amongst the map data having at least one field at least partially matching the input data,
iv) generating a results table populated with entries which each corresponds to at least one matching object, each entry in the results table including data from all or a predetermined selection of the object fields associated with each matching object, and
v) selectively merging together two or more separate entries in the results table which have substantially equivalent data within predetermined groupings of corresponding object fields into a single merged entry, and
vi) outputting the results table.

14. A method of operating a navigation device as claimed in claim 13, wherein the step of selectively merging separate matching objects happens as the results table is being populated.

15. A method of operating a navigation device as claimed in claim 14, wherein the results table is populated using a binary search function to determine the location in the results table to insert or merge each new matching result.

16. A method of operating a navigation device as claimed in claim 15, wherein a new matching result is merged with an existing entry in the results table if a comparison between the result and the entry passes at least one test.

17. A method of operating a navigation device as claimed in claim 16, wherein one of the tests includes dividing the object fields of the new matching result and an existing entry in the results table into a plurality of groups of object fields and carrying out a comparison between the two results on a group by group basis.

18. A method of operating a navigation device as claimed in claim 17, wherein within each group, the data from the new matching result and the existing entry in the preliminary results list is considered to match if the data contained within the object fields of one of the results appears in the same or different object fields of the other result.

19. A method of operating a navigation device as claimed in claim 18, wherein the map data identifies objects and their locations from a plurality of distinct map regions and the step of selectively merging is able to occur on at least some entries from different map regions.

20. A method of operating a navigation device as claimed in claim 19, wherein the map data also contains tuning data which controls the way in which the step of selective merging occurs.

21. A method of operating a navigation device as claimed in claim 20, wherein the tuning data causes the step of selective merging to merge the two or more separate entries in a manner which is dependent upon the geographical region or country in which those objects are located.

22. A method of operating a navigation device as claimed in claim 21, wherein the input step of inputting data allows a user to select an entry from the results table which has been output, wherein selection of a merged entry effectively selects all of the two or more separate matching entries which were merged together to form the merged entry.

23. A method of operating a navigation device as claimed in claim 22, wherein the step of outputting provides the user with the results table subsequent to all matching objects having been merged together.

24. A navigation device comprising:
a data storage device containing map data identifying geographically distributed objects and their locations, each object identified by a series of separate text data-containing object fields,
an input device to allow a user to provide input data indicative of a desired destination location,
control means which executes instructions causing it to search for objects amongst the map data having at least one field at least partially matching the input data and generates a results table populated with entries which each correspond to at least one matching object,
wherein each entry in the results table includes data from all or a predetermined selection of the object fields associated with a matching object, and
wherein the control means also processes the objects in the results table to decide for each matching object which object fields to remove or hide to thereby minimise the amount of data in the results table while retaining sufficient data to allow the objects to be differentiated from one another, and
an output device which provides the user with the results table subsequent to processing.

25. A navigation device as claimed in claim 24, wherein, the control means alphabetically sorts the objects within the results table based upon a first object field of each object, selects a block of contiguous objects in the sorted results table which each have the same data within their first object field, and decides on which object fields to remove or hide for all objects within the selected block.

26. A navigation device as claimed in claim 25, wherein, the object fields are generally ranked from a first, low level or more geographically refined object field to a last, high level or less geographically refined object field.

27. A navigation device as claimed in claim 26, wherein the first object field contains data describing the road name or street name or route name/number of the object.

28. A navigation device as claimed in claim 27, wherein subsequent to sorting the results in the preliminary results table, for each object, the control means eliminates any multiple occurrences of the same text appearing in multiple object fields by deleting or hiding all but one of the multiple object fields.

29. A navigation device as claimed in claim 26, wherein during processing, for any block containing a single object, all but the first and immediately adjacently ranked object fields are removed from or hidden in the results table.

30. A navigation device as claimed in claim 26, wherein during processing, for any block containing more than one object, a counter is provided to determine and store a count, for each object field within the block, of the number of occurrences of each unique text string appearing in that object field over all of the objects, and for each object in the block, all but the first object field and the next most adjacently ranked object field having the lowest count are removed from or hidden in the results table.

31. A navigation device as claimed in claim 26, wherein during processing, for any block containing more than one object,
a counter is provided to determine and store a first count, for each object field within the block, of the number of occurrences of each unique text string appearing in that object field over all of the objects,
the unique text string within each object having the lowest first count is recorded in an eliminated names list,
the objects in the block are alphabetically sorted based upon the first object field and the next most adjacently ranked object field having the lowest first count,
a second count is made, for each object within the block where the unique text string having the lowest first count is not unique to that object, of the number of occurrences of each name appearing in that object field over all of the objects, excluding unique text strings appearing in the excluded names list, and
for each object in the block, all but the first object field and the next most adjacently ranked object field having the lowest first count and the next most adjacently ranked object field having the lowest second count are removed from or hidden in the results table.

32. A navigation device as claimed in claim 31, wherein every separate contiguous block of objects in the results table is separately processed.

33. A navigation device as claimed in claim 32, wherein the results table contains a predetermined maximum number of objects.

34. A navigation device as claimed in claim 33, wherein the map data also contains tuning data which controls the way in which the control means processes the results table to differentiate objects from one another.

35. A navigation device as claimed in claim 34, wherein the tuning data causes the control means to process the results table to differentiate objects from one another in a manner which is dependent upon the country in which those objects are located.

36. A navigation device as claimed in claim 27, wherein immediately prior to the output means providing the user with the results table, the objects in the results table are alphabetically sorted based upon the first object field.

37. A navigation device as claimed in claim 36, wherein the results table is output to the user only after the control means has completed processing it.

38. A navigation device as claimed in claim 24, wherein matching objects are either exact matches whereby they match exactly with the input data or are inexact matches whereby some object's fields match the input data and those fields that do not match the input data match adjacent or nearly adjacent locations to the unmatched input data.

39. A method of operating a navigation device comprising the steps of:
i) providing a data storage device containing map data identifying geographically distributed objects and their locations, each object identified by a series of separate text data containing object fields,
ii) inputting data indicative of a desired destination location,
iii) searching for objects amongst the map data having at least one field at least partially matching the input data,
iv) generating a results table populated with entries which each correspond to at least one matching object, each entry in the results table including data from all or a predetermined selection of the object fields associated with each matching object,
v) processing the objects in the results table to decide for each matching object which object fields to remove or hide to thereby minimise the amount of data in the results table while retaining sufficient data to allow the objects to be differentiated from one another, and
vi) outputting the results table.

40. A method of operating a navigation device as claimed in claim 39, wherein the processing step includes alphabetically sorting the objects within the results table based upon a first object field of each object, selecting a block of contiguous objects in the sorted results table which each have the same data within their first object field, and deciding on which object fields to remove or hide for all objects within the selected block.

41. A method of operating a navigation device as claimed in claim 40, wherein for each object the object fields are ranked from a first, low level or more geographically refined object field to a last, high level or less geographically refined object field.

42. A method of operating a navigation device as claimed in claim 41, wherein subsequent to sorting the results in the results table, for each object, the control means eliminates any multiple occurrences of the same text appearing in multiple object fields by deleting or hiding all but one of the multiple object fields.

43. A method of operating a navigation device as claimed in claim 41, wherein during processing, for any block containing a single object, all but the first and immediately adjacently ranked object fields are removed from or hidden in the results table.

44. A method of operating a navigation device as claimed in claim 41, wherein during processing, for any block containing more than one object, a counter is provided to determine and store a count, for each object field within the block, of the number of occurrences of each unique text string appearing in that object field over all of the objects, and for each object in the block, all but the first object field and the next most adjacently ranked object field having the lowest count are removed from or hidden in the results table.

45. A method of operating a navigation device as claimed in claim 41, wherein during processing, for any block containing more than one object,
a counter is provided to determine and store a first count, for each object field within the block, of the number of occurrences of each unique text string appearing in that object field over all of the objects,
the unique text string within each object having the lowest first count is recorded in an eliminated names list,
the objects in the block are alphabetically sorted based upon the first object field and the next most adjacently ranked object field having the lowest first count,
a second count is made, for each object within the block where the unique text string having the lowest first count is not unique to that object, of the number of occurrences of each name appearing in that object field over all of the objects, excluding unique text strings appearing in the excluded names list, and
for each object in the block, all but the first object field and the next most adjacently ranked object field having the lowest first count and the next most adjacently ranked object field having the lowest second count are removed from or hidden in the results table.

46. A method of operating a navigation device as claimed in claim 40, wherein every separate contiguous block of objects in the results table is separately processed.

47. A method of operating a navigation device as claimed in claim 46, wherein the results table contains a predetermined maximum number of objects.

48. A method of operating a navigation device as claimed in claim 47, wherein the map data also contains tuning data which controls the way in which the results table is processed to differentiate objects from one another.

49. A method of operating a navigation device as claimed in claim 48, wherein the tuning data causes the processing step to differentiate the objects in the results table from one another in a manner which is dependent upon the country in which those objects are located.

50. A method of operating a navigation device as claimed in claim 49, wherein immediately prior to outputting the results table, the objects in the results table are alphabetically sorted based upon the first object field.

51. A method of operating a navigation as claimed in claim 50, wherein the results table is output to the user only after the processing step has been completed.

52. A navigation device comprising:
a data storage device containing map data identifying geographically distributed objects and their locations, each object identified by a series of separate data-containing object fields,
an input device to allow a user to select an object, and
an output device which provides the selected object to the user by arranging its object fields in a predetermined format, wherein the format is selected from a plurality of formats dependent upon the geographical region or country in which the object is located.

53. A navigation device as claimed in claim 52, wherein the input device allows the user to provide input data indicative of a desired destination location, the navigation device further comprising control means which executes instructions causing it to search for objects amongst the map data having at least one field at least partially matching the input data, wherein the input device allows the user to select a matching object which is then provided to the user by the output device in the selected predetermined format.

54. A navigation device as claimed in claim 52, wherein the map data also contains tuning data for each country which defines the predetermined formats for each geographical region or country.

55. A navigation device as claimed in claim 54, wherein the tuning data is comprised of metadata tags within the map data.

56. A navigation device as claimed in claim 55, wherein the map-data contains data on objects from a plurality of countries or district geographic regions.

57. A navigation device as claimed in anyone of claim 56, wherein the output device comprises a display screen or an audio output device which generates audible voice signals corresponding to the formatted object fields.

58. A method of operating a navigation device comprising the steps of:
i) providing a data storage device containing map data identifying geographically distributed objects and their locations, each object identified by a series of separate datacontaining object fields,
ii) selecting an object from the map data, and
iii) outputting the selected object to the user by arranging its object fields in a predetermined format, wherein the format is selected from a plurality of formats dependent upon the country or geographical region in which the object is located.

59. A method of operating a navigation device as claimed in claim 58, further comprising the step of inputting data indicative of a desired destination location and searching for objects amongst the map data having at least one field at least partially matching the input data, wherein the selecting step is carried out on the matching objects.

60. A method of operating a navigation device as claimed in claim 58, wherein the map data also contains tuning data for each country which defines the predetermined formats for each geographic region or country and wherein the step of outputting is carried out based upon the tuning data.
